(19) United States
(12) Patent Application Publication
(10) Pub. No.: US 2009/0167074 A1
(43) Pub. Date: Jul. 2, 2009

(54) SAFETY DEVICE FOR A VEHICLE WHEEL

(76) Inventor: Bernard De Lima, Pessac (FR)

Correspondence Address: YOUNG & THOMPSON, 209 Madison Street, Suite 500, ALEXANDRIA, VA, 22314, US

(21) Appl. No.: 12/278,577

(22) PCT Filed: Feb. 5, 2007
(86) PCT No.: PCT/FR2007/050749

§ 371 Date: Sep. 19, 2008

(30) Foreign Application Priority Data
Feb. 8, 2006 (FR) 0650448

(51) Int. Cl. B60B 3/16

(52) U.S. Cl. 301/35.624; 411/96

(57) ABSTRACT

A safety device (10) for a vehicle wheel (12), whereby said wheel (12) includes a wheel rim (16) that is attached to the hub (18) of the vehicle by attachment screws (20) and is equipped or is able to be equipped with a hub cap (22), characterized in that it includes anti-rotational elements (26) that are provided for working with the attachment screws (20) of the wheel rim (16) on the hub (18) that is integrated with the hub cap. The hub cap (22) that integrates the safety device (10) for a vehicle wheel (12) is also disclosed.

This invention relates to a safety device for a vehicle wheel, and more particularly a device for preventing the connecting elements of said wheel from rotating.

For appearance's sake, many vehicles, regardless of their use, are equipped with hub caps. These elements hide the hub and the attachment elements of the wheel rim as well as the wheel rim itself, whereby most of these wheel rims are fairly unsightly for reasons of cost.

While remaining easily removable, the hub caps can thus ensure protection of the attachment elements of the wheel rim of the wheel against inclement weather and various protrusions. The attachment elements are less susceptible to corrosion and do not seize in their housings; it is thus possible to remove them if necessary.

In contrast, it has been noted that the attachment elements of wheels of certain vehicles, in particular screws, become disengaged little by little from the hub to which they are connected, even if the tightening torque is as specified by the designer. This loosening results from vibrations produced by the irregularities in the pavement, for example, or by more consistent shocks due to more significant imperfections of the surface, of the “pothole” type, for example.

Thus, this disengagement of the attachment screws is not due to great mechanical stresses; only the repetition of shocks and the continuity of vibrations are to blame. A perverse effect of the hub cap, when one is present, is then noted: that of concealing the loosened attachment screws.

Without a regular visual monitoring of these screws, the user of the vehicle may be in danger as well as the other users.

Even in the absence of hub caps, some drivers of vehicles, not very attentive, no longer necessarily pay attention to such loosenings. Various holding devices exist for the purpose of preventing this disengagement of screws in the prior art. These are anti-rotational devices, in the shape of a ring, using as many housings as necessary to lock the screw heads. These devices are grafted on the wheel rim or on the attachment elements by mechanical means that require specific additional equipment that is added to the equipment that is necessary for removing the wheel.

Also, the purpose of this invention is to solve the problems of the prior art by proposing a device for locking nuts or screws of wheels, integrated in the hub cap of said wheel, easily removable so as not to require special or additional equipment. Said locking and therefore safety device prevents the rotation of the attachment elements of said wheel.

For this purpose, the object of the invention is a safety device for a vehicle wheel, whereby said wheel comprises a wheel rim, attached to the hub of said vehicle by attachment screws and equipped with a hub cap, characterized in that it comprises anti-rotational means borne by the hub cap and provided to work with the screws for attaching the wheel rim on the hub.

For the remainder of the description, “screw” is defined as either screws that work with threaded holes in the hub or nuts that are provided to be screwed onto the bolts that are integral with said hub.

Other characteristics and advantages will emerge from the following description of the invention, a description that is provided only by way of example, taking into account the accompanying drawings, in which:

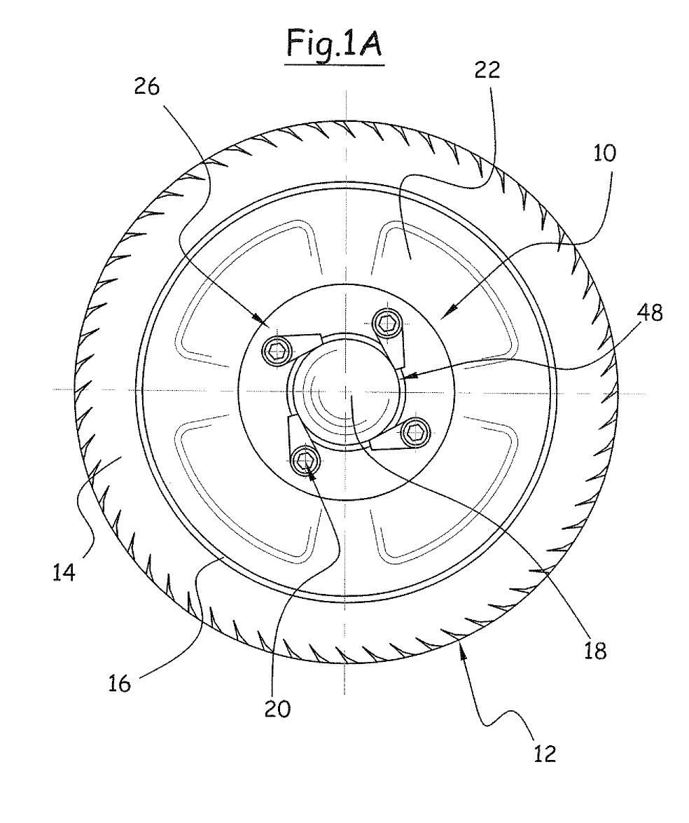

FIG. 1A shows a vehicle wheel that is equipped with a safety device according to the invention,

FIG. 1B is a transversal cut-away view of the safety device of FIG. 1A,

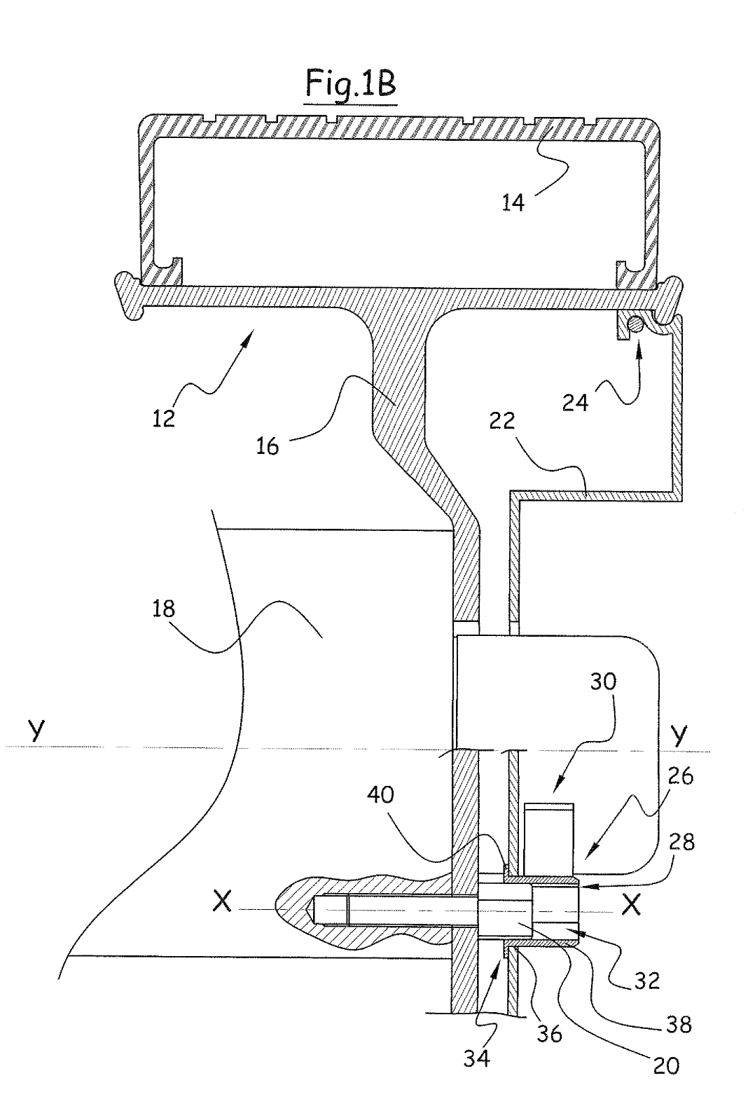

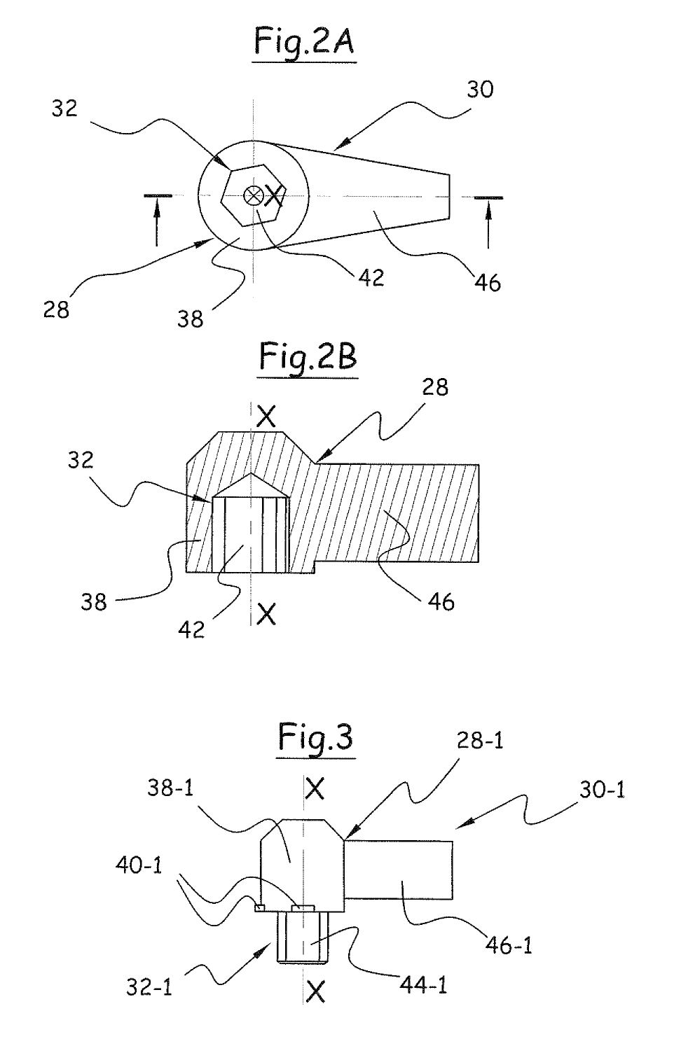

FIGS. 2A and 2B show, respectively, a bottom view and a transversal cutaway view of a cap,

FIG. 3 shows, in a side view, a variant embodiment of a cap,

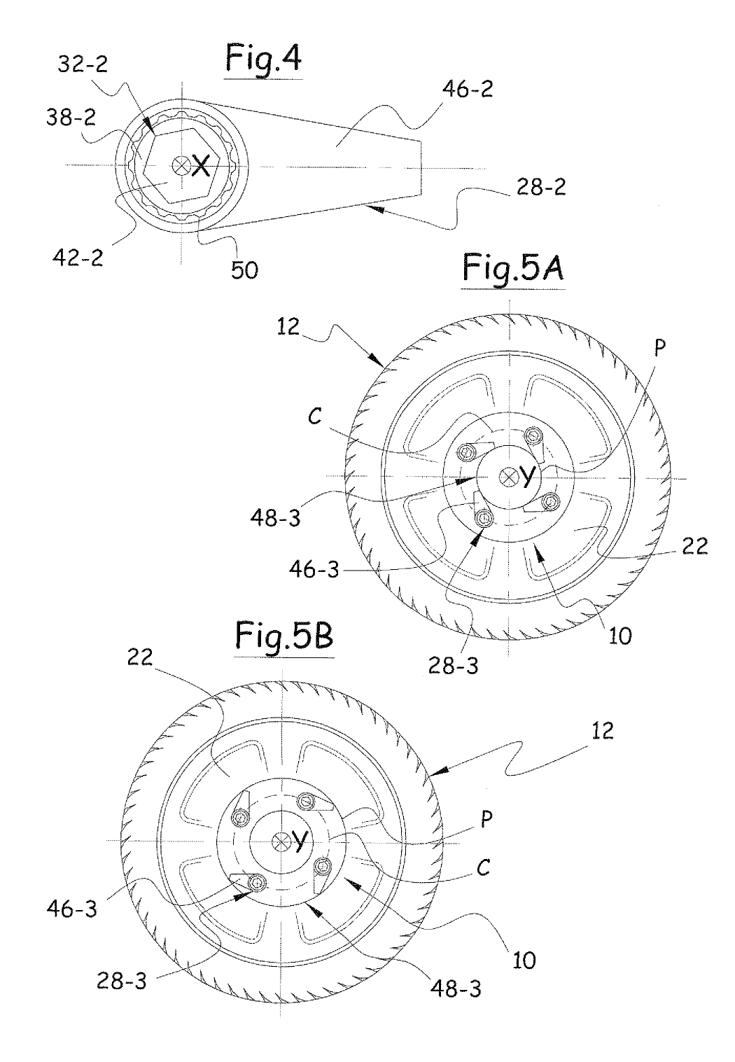

FIG. 4 illustrates a second embodiment of the safety means of the invention,

FIGS. 5A and 5B illustrate a third embodiment,

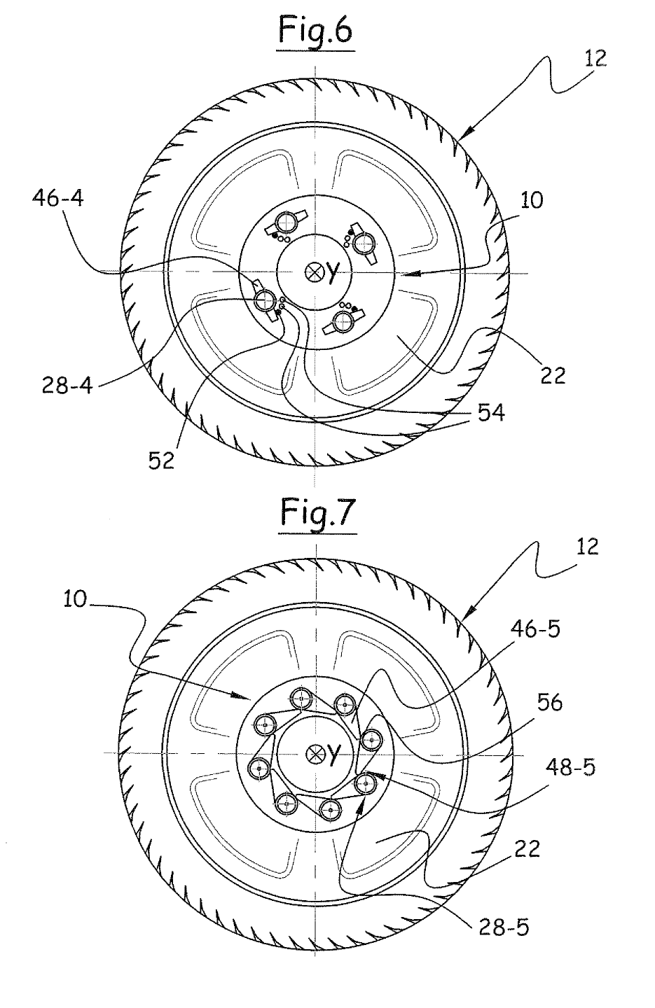

FIG. 6 shows a fourth variant embodiment,

FIG. 7 illustrates a fifth variant embodiment,

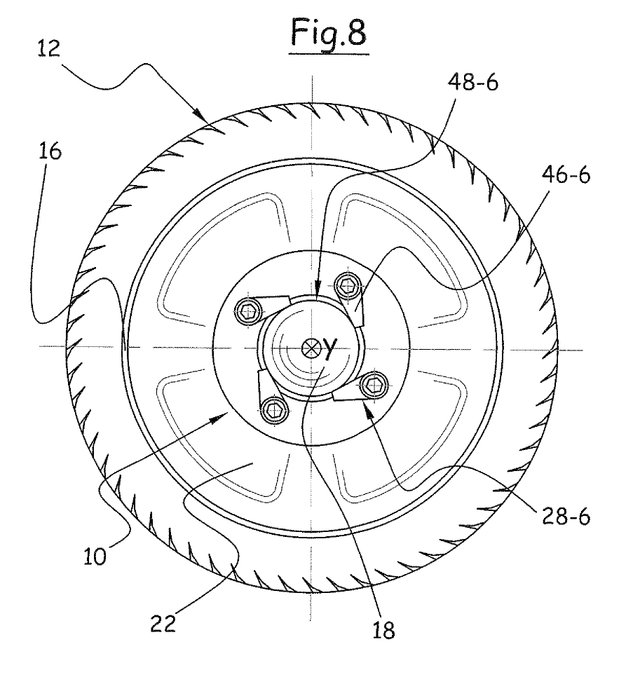

FIG. 8 illustrates a sixth variant embodiment.

The safety device 10 for a vehicle wheel 12 according to the invention is illustrated by FIGS. 1A and 1B in its general structure.

Wheel 12 comprises a tire 14 that is mounted on a wheel rim 16 attached to the hub 18 by attachment screws 20.

A hub cap 22 that integrates the safety device 10 is connected to the wheel rim 16 by known means of the prior art, for example using clamp 24 that facilitates the mounting and removal of said hub cap 22 without a special tool.

The safety device 10 for vehicle wheel 12 according to this invention incorporates anti-rotational means 26 that are provided to prevent a rotation, in particular loosening of the attachment screws 20, able to bring about a disengagement of the wheel 12 from the vehicle.

The anti-rotational means 26, presented in detail in FIG. 1B, of the safety device 10 comprise at least one cap 28 and means 30 for preventing said caps from rotating.

Each cap 28 is connected in rotation with each of the attachment screws 20 of the wheel rim 16 that is integral with the hub 18 to which it is secured.

The means for connecting in rotation each of the caps 28 of the safety device 10 with each screw comprises interlocking means 32, generally a conjugated profile of the screw head in the case of a screw with a hexagonal head, see FIGS. 2A and 2B, or a screw with a head with six hollow sections.

Each cap 28 of the safety device 10 is mounted to rotate freely relative to the hub cap that carries it so as to make its orientation possible.

For this purpose, the caps 28 have an essentially cylindrical body and use attachment means 34 such as those that are illustrated on the cap 28 shown in section in FIG. 1B. These attachment means 34 comprise holes 36, with a diameter that is essentially equal to that of the body 38 of the cap 28, provided in the hub cap 22 opposite each attachment screw 20 for the passage of said bodies 38. Keeping each body 38 of cap 28 in position in a hole 36 of the hub cap 22 is ensured by, for example, lugs 40.

Other attachment means 34, known to one skilled in the art, can be used as long as they allow the cap 28 to rotate while keeping it on the hub cap 22 during the use of the vehicle, in particular a groove with a snap ring.

As illustrated in FIG. 3, in the case of a screw 20 that has a head with six hollow sections, the cap 28-1 uses a hexagonal projecting part 44-1, suitable for being housed in said standard screw head with six hollow sections, with action close to locking together. The other elements, lugs 40-1, cap body 38-1, and locking means 30-1 remain unchanged.

In addition, the locking means 30 in rotation comprise at least one index 46 that can rest against support means 48.

In the general diagrammatic embodiment, this index 46 is oriented in an essentially perpendicular manner to the axis of rotation X of the cap, which is combined with the axis of rotation of the attachment screw 20.

The operation of the safety device according to this invention is now described in its general mode with female adaptation for the hexagonal screw head or with male adaptation for the screw head with six hollow sections.

The individual responsible for maintenance, who will be called the driver for the sake of convenience, installs a hub cap 22 on each of the wheels. The hub cap is connected to the wheel rim 16, and the caps 28 of the safety device 10 of the hub cap 22 are installed and oriented by making them work with the heads 20 of the attachment screws.

The means 30 for locking in rotation will prevent the rotation of the caps 28. Actually, in the event of loosening starting, the screw 20 rotates on a very limited angular sector because the cap 28 that is integral with it in rotation rotates simultaneously. The rotation of the cap also moves the index 46 in rotation that comes into contact with the support means 48, in this case the hub of the projecting wheel.

Consequently, the screw 20 can no longer become loosened unexpectedly under the action of vibrations and other shocks.

FIG. 4 illustrates a second embodiment in which the index 46-2 of the cap 28-2 is mounted on a “pawl system” 50 that allows the manual rotation of said index 46-2 around the body 38-2 of the cap 28-2 in the direction opposite to the direction of disengagement of the attachment screws 20.

Thus, during the mounting of the hub cap 22 that incorporates a safety device 10 with the caps 28-2 that are designed according to this embodiment, the index 46-2 can be brought to a stop close to the support means 48 upon activation, thus keeping loosening from even starting.

As a variant, it is possible to provide support means 48 of the indices 46 of caps 28, essential to their locking in rotation, which are borne by the hub cap 22 itself or by elements outside of said hub cap 22.

Thus, according to a third variant embodiment of the device, shown in FIGS. 5A and 5B, the support means 48-3 of the indices 46-3 of the caps 28-3 comprise a wall P that is located directly on the hub cap so as to achieve the locking of the indices 46-3. This wall P is placed preferably close to the indices 46-3 of the caps.

The attachment screws 20 being essentially distributed along a circle C whose center corresponds to the axis Y of rotation of the wheel 12, this wall P projects toward the outside and the height is essentially equal to that of the caps 28-3. In FIG. 5A, this wall P has a diameter that is appreciably less than the circle C for distribution of the attachment screws 20 and therefore offers its outer surface as support means 48-3 to the indices 46-3 of the caps 28-3.

In FIG. 5B, this wall P has a diameter that is appreciably larger than the circle C for distribution of the attachment screws 20 and therefore offers its inner surface as support means 48-3 to the indices 46-3 of caps 28-3.

According to a fourth variant of the support means 48-4, illustrated in FIG. 6, at least one approximately cylindrical axis 52, for example a pin, with a height that is approximately equal to that of the cap 28-4, is provided.

Ideally, several positions 54 close to a cap 28-4 for the axis 52 are provided.

According to a fifth variant illustrated in FIG. 7, the locking of at least one index 46-5 of each cap 28-5 of the safety device 10 is achieved by the adjacent cap 28-5. In this case, the index 46-5 of each cap 28-5 should be long enough to rest on the adjacent cap 28-5.

According to a sixth variant illustrated in FIG. 8, the locking of the indices 46-6 of the caps 28-6 of the safety device 10 is achieved by resting directly on the hub 18 when the latter is projecting.

Advantageously, the hub cap 22 can comprise one more part, called a mask, whereby the purpose of this part is to improve the appearance of a hub cap 22 by concealing the safety device 10 for the vehicle wheel 12. This mask is attached to the hub cap 22 by means that are known to one skilled in the art.

Of course, the invention obviously is not limited to the embodiment shown and described above, but on the contrary covers all the variants, in particular regarding the materials that are used, the sizes and shapes of the safety device 10, its caps 28 and the associated hub cap 22.

1. Safety device (10) for a vehicle wheel (12), whereby said wheel (12) comprises a wheel rim (16) that is attached to the hub (18) of said vehicle by attachment screws (20) and is equipped with a hub cap (22), characterized in that it comprises anti-rotational means (26) that are provided for working with the attachment screws (20) of the wheel rim (16) on the hub (18) and are integrated with said hub cap.

2. Safety device (10) according to claim 1, wherein the anti-rotational means (26) of the safety device (10) comprise a cap (28) that works with at least one attachment screw (20) and means (30) for preventing said caps (28) from rotating.

3. Safety device (10) according to claim 2, wherein each cap (28) comprises interlocking means (32) that are able to work with an attachment screw (20).

4. Safety device (10) according to claim 3, wherein the interlocking means (32) are adapted to the shape of the head of the attachment screws (20).

5. Safety device (10) according to claim 2, wherein the means (30) for preventing a cap (28) from rotating comprise at least one index (46) that is integral with the cap (28) that is able to work with support means (48).

6. Safety device (10) according to claim 5, wherein each index (46-2) of cap (28-2) is mounted on each cap (28-2) by means of a pawl system (50).

7. Safety device (10) according to claim 5, wherein the support means (48) of the indices (46) of the caps (28) comprise a wall P, essentially cylindrical, integral with the hub cap (22).

8. Safety device (10) according to claim 5, wherein the support means (48) of at least one index (46) of each cap (28) comprise at least one axis (52) that can assume several positions (54).

9. Safety device (10) according to claim 5, wherein the support means (48) of at least one index (46) of each cap (28) consist of the adjacent cap (28).

10. Hub cap (22) that integrates the safety device (10) for a vehicle wheel (12) according to claim 1.

11. Safety device (10) according to claim 3, wherein the means (30) for preventing a cap (28) from rotating comprise at least one index (46) that is integral with the cap (28) that is able to work with support means (48).

12. Safety device (10) according to claim 4, wherein the means (30) for preventing a cap (28) from rotating comprise at least one index (46) that is integral with the cap (28) that is able to work with support means (48).

13. Safety device (10) according to claim 6, wherein the support means (48) of the indices (46) of the caps (28) comprise a wall P, essentially cylindrical, integral with the hub cap (22).

14. Safety device (10) according to claim 6, wherein the support means (48) of at least one index (46) of each cap (28) comprise at least one axis (52) that can assume several positions (54).

15. Safety device (10) according to claim 6, wherein the support means (48) of at least one index (46) of each cap (28) consist of the adjacent cap (28).

16. Safety device (10) according to claim 11, wherein the support means (48) of the indices (46) of the caps (28) comprise a wall P, essentially cylindrical, integral with the hub cap (22).

17. Safety device (10) according to claim 11, wherein the support means (48) of at least one index (46) of each cap (28) comprise at least one axis (52) that can assume several positions (54).

18. Safety device (10) according to claim 11, wherein the support means (48) of at least one index (46) of each cap (28) consist of the adjacent cap (28).

19. Safety device (10) according to claim 12, wherein the support means (48) of the indices (46) of the caps (28) comprise a wall P, essentially cylindrical, integral with the hub cap (22).

20. Safety device (10) according to claim 12, wherein the support means (48) of at least one index (46) of each cap (28) comprise at least one axis (52) that can assume several positions (54).
